(19) United States
(12) Patent Application Publication
(10) Pub. No.: US 2007/0072079 A1
(43) Pub. Date: Mar. 29, 2007

(54) Hydrogen-absorbing alloy electrode, alkaline storage battery, and method of manufacturing the alkaline storage battery

(76) Inventors: Shigekazu Yasuoka, Kobe-shi (JP); Yoshifumi Magari, Kobe-shi (JP); Jun Ishida, Kobe-shi (JP)

Correspondence Address: KUBOVCIK & KUBOVCIK, SUITE 710, 900 17TH STREET NW, WASHINGTON, DC, 20006, US

(21) Appl. No.: 11/528,312

(22) Filed: Sep. 28, 2006

(30) Foreign Application Priority Data
Sep. 28, 2005 (JP) 2005-281103
Feb. 28, 2006 (JP) 2006-051841

(51) Int. Cl. H01M 4/58

(52) U.S. Cl. 429/218.2; 29/623.1

(57) ABSTRACT

Conductivity of a negative electrode is improved in an alkaline storage battery that uses as its negative electrode a hydrogen-absorbing alloy electrode employing a hydrogen-absorbing alloy containing at least a rare-earth element, nickel, magnesium, and aluminum, to sufficiently enhance the cycle life of the alkaline storage battery. The negative electrode of the alkaline storage battery uses a hydrogen-absorbing alloy electrode employing hydrogen-absorbing alloy particles containing at least a rare-earth element, nickel, magnesium, and aluminum. A surface layer is formed on the hydrogen-absorbing alloy particles, the surface layer having a weight ratio of aluminum to nickel less than that of the interior portion of the hydrogen-absorbing alloy. The weight ratio of aluminum to nickel in the surface layer is 0.015 or less.

### BACKGROUND OF THE INVENTION

1. Field of the Invention

The present invention relates to hydrogen-absorbing alloy electrodes for use as negative electrodes in alkaline storage batteries. The invention also relates to alkaline storage batteries and methods of manufacturing the alkaline storage batteries. More particularly, the invention relates to an improved hydrogen-absorbing alloy electrode for use as a negative electrode in an alkaline storage battery, that is designed to improve the cycle life of the alkaline storage battery.

2. Description of Related Art

Conventionally, nickel-cadmium storage batteries have been commonly used as alkaline storage batteries. In recent years, nickel-metal hydride storage batteries employing a hydrogen-absorbing alloy as a material for their negative electrodes have drawn considerable attention in that they have higher capacity than nickel-cadmium storage batteries and that, being free of cadmium, they are more environmentally safe.

Because alkaline storage batteries comprising the nickel-metal hydride storage batteries have been used in various portable devices, demands for further higher performance in the alkaline storage batteries have been increasing.

In the alkaline storage batteries, hydrogen-absorbing alloys such as a rare earth-nickel hydrogen-absorbing alloy having a CaCu5 crystal structure as its main phase and a Laves phase hydrogen-absorbing alloy containing Ti, Zr, V and Ni have been commonly used for the negative electrodes.

However, these hydrogen-absorbing alloys do not necessarily have sufficient hydrogen-absorbing capability, and it has been difficult to enhance the capacity of the alkaline storage batteries further.

In recent years, in order to improve the hydrogen-absorbing capability of the rare earth-nickel hydrogen-absorbing alloys, it has been proposed to use a hydrogen-absorbing alloy having a Ce₂Ni₇ type or a CeNi₃ type crystal structure, other than the CaCu₅ type, by adding Mg or the like to the rare earth-nickel hydrogen-absorbing alloy. (See, for example, Japanese Unexamined Patent Publication No. 2002-69554.)

A problem with the alkaline storage battery that uses as its negative electrode the hydrogen absorbing alloy electrode employing a hydrogen absorbing alloy in which Mg or the like is added to a rare earth-nickel hydrogen absorbing alloy is, however, that the battery capacity deteriorates significantly as charge and discharge cycles are repeated, so a sufficient cycle life cannot be obtained.

Japanese Published Unexamined Patent Application No. 2001-118597, for example, proposes an alkaline storage battery that employs a hydrogen-absorbing alloy electrode using a hydrogen-absorbing alloy as its negative electrode, wherein an aluminum compound is added to or, is brought into contact with, an alkaline electrolyte solution, to improve the cycle life of the alkaline storage battery.

Nevertheless, even with the alkaline storage battery in which an aluminum compound is added to, or brought into contact with, an alkaline electrolyte solution, it has still been difficult to enhance the battery cycle life sufficiently.

### BRIEF SUMMARY OF THE INVENTION

Accordingly, it is an object of the present invention to resolve the foregoing and other issues in the alkaline storage battery that uses as the negative electrode a hydrogen-absorbing alloy electrode employing a hydrogen-absorbing alloy. In particular, it is an object of the present invention to enhance conductivity in the negative electrode in an alkaline storage battery that uses as the negative electrode a hydrogen-absorbing alloy electrode employing a hydrogen-absorbing alloy containing at least a rare-earth element, nickel, magnesium, and aluminum so that the cycle life of the alkaline storage battery can be improved sufficiently.

In order to accomplish the foregoing and other objects, the present invention provides a hydrogen-absorbing alloy electrode comprising hydrogen-absorbing alloy particles containing at least a rare-earth element, nickel, magnesium, and aluminum, the hydrogen-absorbing alloy having an interior portion and a surface layer formed thereon, wherein the surface layer has a weight ratio of aluminum to nickel less than that of the interior portion, and the weight ratio of aluminum to nickel in the surface layer is 0.015 or less.

### BRIEF DESCRIPTION OF THE DRAWINGS

FIG. 1 is a schematic cross-sectional view illustrating an alkaline storage battery as prepared in Example 1 and Comparative Example 1 of the present invention.

### DETAILED DESCRIPTION OF THE INVENTION

A hydrogen-absorbing alloy electrode according to the present invention comprises hydrogen-absorbing alloy particles containing at least a rare-earth element, nickel, magnesium, and aluminum. The hydrogen-absorbing alloy particles have an interior portion and a surface layer formed thereon. The surface layer has a weight ratio of aluminum to nickel that is less than that of the interior portion, and the weight ratio of aluminum to nickel in the surface layer is 0.015 or less.

In the just-described hydrogen-absorbing alloy electrode, it is preferable that the hydrogen-absorbing alloy particles containing at least a rare-earth element, nickel, magnesium, and aluminum be represented by the general formula Ln₁₋ₓMgₓNi_{y-a-b}AlₐM_{b}, where Ln is at least one element selected from rare-earth elements including Y; M is at least one element selected from the group consisting of V, Nb, Ta, Cr, Mo, Mn, Fe, Co, Ga, Zn, Sn, In, Cu, Si, P, B, Zr, and Ti; 0.05≦x≦0.35; 2.8≦y≦3.9; 0.05≦a≦0.30; and 0≦b≦0.5. The size of the particles is generally from about 20 to 100 μm. The thickness of the surface layer formed on the particles varies between about 0.20 to 1 μm.

An alkaline storage battery according to the present invention employs the just-described hydrogen-absorbing alloy electrode for the negative electrode.

The alkaline storage battery employing the hydrogen-absorbing alloy electrode for the negative electrode as described above may be manufactured by the following method. The method comprises assembling an alkaline storage battery provided with a positive electrode; a negative electrode comprising hydrogen-absorbing alloy particles containing at least a rare-earth element, nickel, magnesium, and aluminum; a separator to be interposed between the positive electrode and the negative electrode; and an alkaline electrolyte solution; and thereafter charging and discharging the alkaline storage battery.

In the charging and discharging of the assembled alkaline storage battery as described above, it is preferable to set aside the alkaline storage battery under high temperature, and to charge and discharge the alkaline storage battery after the battery voltage has stabilized. In addition, it is preferable that the alkaline storage battery is set aside at a temperature within a range of from 45° C. to 60° C.

When manufacturing the alkaline storage battery, it is preferable to combine an aluminum compound with the hydrogen-absorbing alloy particles containing at least a rare-earth element, nickel, magnesium, and aluminum in the negative electrode in assembling the alkaline storage battery. It is preferable that the aluminum compound combined with the hydrogen-absorbing alloy particles of the negative electrode be an oxide or hydroxide of aluminum. It is preferable that the amount of the aluminum compound combined with the hydrogen-absorbing alloy particles of the negative electrode be within a range of from 0.05 weight % to 0.3 weight % with respect to the hydrogen-absorbing alloy particles.

### ADVANTAGES OF THE INVENTION

In the present invention, the hydrogen-absorbing alloy electrode used for an alkaline storage battery employs hydrogen-absorbing alloy particles containing at least a rare-earth element, nickel, magnesium, and aluminum and having an interior portion and a surface layer formed thereon. The surface layer has a weight ratio of aluminum to nickel that is less than that of the interior portion, and the weight ratio of aluminum to nickel in the surface layer is controlled to be 0.015 or less. Consequently, the nickel present in the surface layer in large quantities serves to improve the conductivity of the negative electrode and to improve the operating voltage during charge and discharge. Moreover, the amount of aluminum in the surface layer is small, preventing degradation in the conductivity of the negative electrode due to aluminum, and it becomes possible to prevent the degradation in discharge capacity resulting from degradation in operating voltage when charge-discharge cycles are repeated. Thus, a sufficient cycle life is obtained.

A hydrogen-absorbing alloy represented by the general formula Ln_{l=31 x}MgₓNi_{y-a-b}AlₐM_{b}, where Ln is at least one element selected from the rare-earth elements including Y; M is at least one element selected from the group consisting of V, Nb, Ta, Cr, Mo, Mn, Fe, Co, Ga, Zn, Sn, In, Cu, Si, P, B, Zr, and Ti; 0.05≦x≦0.35; 2.8≦y≦3.9; 0.05≦a≦0.30; and 0≦b≦0.5, has a Ce₂Ni₇ type or similar crystal structure, not a conventional CaCu₅ type structure. The just-mentioned hydrogen-absorbing alloy has high hydrogen-absorbing capability and is not prone to pulverization. Therefore, the use of the hydrogen-absorbing alloy improves the capacity of the alkaline storage battery and allows the surface layer to be maintained for a long time, further improving the cycle life.

In the present invention, the alkaline storage battery employing the hydrogen-absorbing alloy electrode for the negative electrode as described above may be manufactured by assembling an alkaline storage battery using a positive electrode; a negative electrode comprising hydrogen-absorbing alloy particles containing at least a rare-earth element, nickel, magnesium, and aluminum; a separator to be interposed between the positive electrode and the negative electrode; and an alkaline electrolyte solution, and thereafter charging and discharging the alkaline storage battery. Thereby, the aluminum contained in the hydrogen-absorbing alloy particles is dissolved by the alkaline electrolyte solution on the surface side of the hydrogen-absorbing alloy particles and is caused to adhere on the separator. Consequently, the amount of aluminum that redeposits on the surface of the hydrogen-absorbing alloy particles is reduced, and thus, a surface layer is formed, in which the weight ratio aluminum to nickel is 0.015 or less as described above.

Here, when charging and discharging the assembled alkaline storage battery as described above, the assembled alkaline storage battery is heated and set aside under high temperature, and the alkaline storage battery is charged and discharged after the battery voltage has stabilized. This allows the aluminum contained in the hydrogen-absorbing alloy particles to dissolve in the alkaline electrolyte solution efficiently and adhere onto the separator. In particular, when the alkaline storage battery is set aside at a temperature of from 45° C. to 60° C., the dissolution of the aluminum contained in the hydrogen-absorbing alloy particles into the alkaline electrolyte solution is promoted, so the surface layer in which the weight ratio of aluminum to nickel is 0.015 or less is formed appropriately, and moreover, the battery voltage is stabilized, and overvoltage at the initial stage of charging is prevented. Thus, the cycle life improves further.

When forming the surface layer in which the weight ratio of aluminum to nickel is 0.015 or less by charging and discharging the assembled alkaline storage battery as described above, an aluminum compound is combined with the hydrogen-absorbing alloy particles of the negative electrode which contain at least a rare-earth element, nickel, magnesium, and aluminum. This enables the added aluminum compound to dissolve in the alkaline electrolyte solution before the charging and discharging and adhere onto the separator, allowing the aluminum that is dissolved from the hydrogen-absorbing alloy particles into the alkaline electrolyte solution by the charging and discharging to adhere onto the separator more easily. Consequently, the amount of aluminum that redeposits on the surface of the hydrogen-absorbing alloy particles becomes small, making it possible to appropriately form the surface layer in which the weight ratio of aluminum to nickel is 0.015 or less. It is preferable that the aluminum compound combined with the hydrogen-absorbing alloy particles of the negative electrode be an oxide or hydroxide of aluminum. In addition, it is preferable that the amount of the aluminum compound combined with the hydrogen-absorbing alloy particles of the negative electrode be within a range of from 0.05 weight % to 0.3 weight % with respect to the hydrogen-absorbing alloy particles. The reason is that if the amount of the combined aluminum compound is too large, the battery internal pressure is likely to increase and electrolyte leakage tends to occur, while if the amount of the combined aluminum compound is too small, the above-described advantageous effects will not be attained sufficiently.

### EXAMPLES

Hereinbelow, examples of the hydrogen-absorbing alloy electrode, the alkaline storage battery, and the method of manufacturing the alkaline storage battery according to the present invention are described in detail along with comparative examples, and it will be demonstrated that the examples of the alkaline storage battery exhibit improved cycle life. It should be construed that the hydrogen-absorbing alloy electrode, the alkaline storage battery, and the method of manufacturing the alkaline storage battery according to the present invention are not limited to those shown in the following examples, and various changes and modifications are possible without departing from the scope of the invention.

### Example 1

In Example 1, a hydrogen-absorbing alloy electrode for use as a negative electrode was prepared in the following manner. Rare-earth elements La, Pr, and Nd were mixed with Mg, Ni, Al, and Co so that a predetermined alloy composition was obtained. Then, the mixture was melted at 1500° C. by an induction furnace and was thereafter cooled to obtain an ingot of hydrogen-absorbing alloy. The resultant hydrogen-absorbing alloy was analyzed by inductively-coupled plasma spectrometry (ICP) . As a result, the composition of the resultant hydrogen-absorbing alloy was found to be (La_{0.2}Pr_{0.5}Nd_{0.3})_{0.83}Mg_{0.l7}Ni_{3.03}Al_{0.17}Co_{0.1}.

The ingot of the hydrogen-absorbing alloy was annealed at 950° C. for 10 hours in an argon atmosphere to make it uniform in quality, and thereafter the ingot of the hydrogen-absorbing alloy was mechanically pulverized in an inert atmosphere. The pulverized alloy was then classified to obtain a powder of the hydrogen-absorbing alloy having the foregoing composition. The resultant hydrogen-absorbing alloy powder was analyzed by a laser diffraction/scattering particle-size analyzer to determine its particle size distribution, and it was found that the average particle size obtained at 50% integral value of weight was 65 μm.

Next, 0.3 parts by weight of an aluminum compound Al(OH)₃ was added to 100 parts by weight of the foregoing hydrogen-abosorbing alloy powder, and further, 0.4 parts by weight of sodium polyacrylic acid, 0.1 parts by weight of carboxymethylcellulose, and 2.5 parts by weight of a polytetrafluoroethylene dispersion solution (dispersion medium: water, solid content: 60 weight %) were mixed with the just-described mixture, to thus prepare a paste. The resultant paste was applied onto both sides of a conductive core substrate made of a 60-μm thick nickel-plated punched metal, and was then dried. The resultant material was pressed and thereafter cut into predetermined dimensions. Thus, a hydrogen-absorbing alloy electrode for use as the negative electrode was prepared.

A positive electrode was prepared in the following manner. Nickel hydroxide powder containing 2.5 weight % of zinc and 1.0 weight % of cobalt was put into an aqueous solution of cobalt sulfate, and 1 mole of an aqueous solution of sodium hydroxide was gradually dropped into the mixture with stirring to cause them to react with each other until the pH reached 11. Thereafter, the resulting precipitate was filtered, washed with water, and vacuum dried. Thus, a positive electrode material was obtained, in which the surface of the nickel hydroxide was coated with sodium-containing cobalt oxide.

Subsequently, 95 parts by weight of the positive electrode material thus prepared, 3 parts by weight of zinc oxide, and 2 parts by weight of cobalt hydroxide were mixed together, and 50 parts by weight of an aqueous solution of 0.2 weight % hydroxypropylcellulose was added to the mixture. These were mixed together to prepare a slurry. The slurry was then filled into a nickel foam having a weight per unit area of 600 g/m². The resultant was dried and pressed, and thereafter cut into predetermined dimensions. Thus, a positive electrode of a non-sintered nickel electrode was prepared.

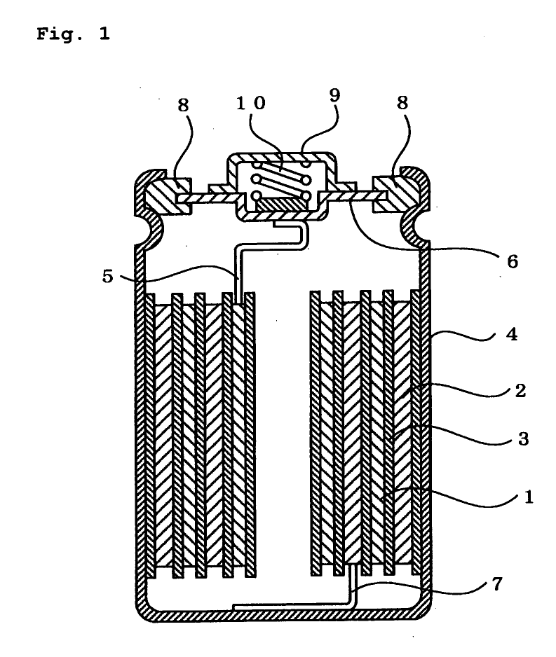

Next, using the positive electrode and the negative electrode prepared in the above-described manner, an alkaline storage battery was assembled. A nonwoven fabric made of polypropylene was used as a separator, and an alkaline aqueous solution that contained KOH, NaOH, and LiOH—H₂O in a weight ratio of 8:0.5:1, the total of which accounted for 30 weight %, was used as an alkaline electrolyte solution. Thus, a cylindrical alkaline storage battery as shown in FIG. 1 with a design capacity of 1500 mAh was fabricated.

The just-described alkaline storage battery was fabricated in the following manner. The positive electrode 1 and the negative electrode 2 were spirally coiled with the separator 3 interposed therebetween, as illustrated in FIG. 1, and these were accommodated in a battery can 4. Then, the alkaline electrolyte solution was poured into the battery can 4. Thereafter, an insulative packing 8 was placed between the battery can 4 and a positive electrode cap 6, and the battery can 4 was sealed. The positive electrode 1 was connected to the positive electrode cap 6 by a positive electrode lead 5, and the negative electrode 2 was connected to the battery can 4 via a negative electrode lead 7. The battery can 4 and the positive electrode cap 6 were electrically insulated by the insulative packing 8. A coil spring 10 was placed between the positive electrode cap 6 and a positive electrode external terminal 9. The coil spring 10 can be compressed to release gas from the interior of the battery to the atmosphere when the internal pressure of the battery unusually increases.

Next, the alkaline storage battery fabricated in the above-described manner was set aside in the atmosphere at a temperature of 45° C. for 10 hours. Thereafter, the alkaline storage battery was charged at a current of 150 mA for 16 hours and thereafter discharged at a current of 1500 mA until the battery voltage reached 1.0 V. This charge-discharge cycle was repeated three times, whereby an alkaline storage battery of Example 1 was obtained.

### Example 2

In Example 2, an alkaline storage battery was prepared in the same manner as in Example 1 above, except that 0.15 parts by weight of aluminum compound Al(OH)₃ was added to 100 parts by weight of the hydrogen-absorbing alloy powder when preparing the hydrogen-absorbing alloy electrode as in Example 1 above. The alkaline storage battery thus prepared was charged and discharged in the same manner as in Example 1, and thus, an alkaline storage battery of Example 2 was obtained.

### Example 3

In Example 3, an alkaline storage battery was prepared in the same manner as in Example 1 above, except that when preparing the hydrogen-absorbing alloy electrode as in Example 1 above, 0.15 parts by weight of aluminum compound Al(OH)₃ was added to 100 parts by weight of the hydrogen-absorbing alloy powder, as in the case of Example 2 above, and that the alkaline storage battery thus prepared was set aside in an atmosphere at a temperature of 60° C. for 10 hours before charging and discharging the alkaline storage battery. Thus, an alkaline storage battery of Example 3 was obtained.

### Example 4

In Example 4, an alkaline storage battery was prepared in the same manner as in Example 1 above, except that 0.05 parts by weight of aluminum compound Al(OH)₃ was added to 100 parts by weight of the hydrogen-absorbing alloy powder when preparing the hydrogen-absorbing alloy electrode as in Example 1 above. The alkaline storage battery thus prepared was charged and discharged in the same manner as in Example 1. Thus, an alkaline storage battery of Example 4 was obtained.

### Example 5

In Example 5, an alkaline storage battery was prepared in the same manner as in Example 1 above, except that when preparing the hydrogen-absorbing alloy electrode as in Example 1 above, 0.05 parts by weight of aluminum compound Al(OH)₃ was added to 100 parts by weight of the hydrogen-absorbing alloy powder, as in the case of Example 4 above, and that the alkaline storage battery thus prepared was set aside in an atmosphere at a temperature of 60° C. for 10 hours before charging and discharging the prepared alkaline storage battery. Thus, an alkaline storage battery of Example 5 was obtained.

### Comparative Example 1

In Comparative Example 1, an alkaline storage battery was prepared in the same manner as in Example 1 above, except that no aluminum compound Al(OH)₃ was added to the hydrogen-absorbing alloy powder when preparing the hydrogen-absorbing alloy electrode as in Example 1 above. The prepared alkaline storage battery was charged and discharged in the same manner as in Example 1. Thus, an alkaline storage battery of Comparative Example 1 was obtained.

### Comparative Example 2

In Comparative Example 2, an alkaline storage battery was prepared in the same manner as in Example 1 above, except that when preparing the hydrogen-absorbing alloy electrode as in Example 1 above, no aluminum compound Al(OH)₃ was added to the hydrogen-absorbing alloy powder, as in the case of Comparative Example 1 above, and that the alkaline storage battery thus prepared was set aside in an atmosphere at a temperature of 60° C. for 10 hours before charging and discharging the alkaline storage battery. Thus, an alkaline storage battery of Comparative Example 2 was obtained.

### Comparative Example 3

In Comparative Example 3, an alkaline storage battery was prepared in the same manner as in Example 1 above, except that when preparing the hydrogen-absorbing alloy electrode as in Example 1 above, no aluminum compound Al(OH)₃ was added to the hydrogen-absorbing alloy powder, as in the case of Comparative Example 1 above, and that the alkaline storage battery thus prepared was set aside in an atmosphere at a temperature of 25° C. for 10 hours before charging and discharging the alkaline storage battery. Thus, an alkaline storage battery of Comparative Example 3 was obtained.

The alkaline storage batteries prepared according to Examples 1 to 4 and Comparative Example 1 were disassembled, and the hydrogen-absorbing alloy particles in the respective negative electrodes were taken out, washed with water, and then dried. Thereafter, an elementary analysis was conducted by electron probe X-ray microanalysis (EPMA) for the surface layers and the bulk portions of the interior portions of the respective hydrogen-absorbing alloy particles, to determine the weight ratios of Al to Ni (Al/Ni) in the surface layers of the respective hydrogen-absorbing alloy particles and the bulk portions of the interior portions thereof. The results are shown in Table 1 below.

TABLE 1

| | | Temperature | | |
|---|---|---|---|---|
| | Amount of | at which | | |
| | Al(OH)₃ with | battery was | Al/Ni | |
| | respect to | set aside | (weight ratio) | |
| | hydrogen- | before | | Alloy |
| | absorbing | charge and | Alloy | interior |
| | alloy | discharge | surface | portion |
| Example 1 | 0.30 wt. % | 45° C. | 0.015 | 0.032 |
| Example 2 | 0.15 wt. % | 45° C. | 0.007 | 0.032 |
| Example 3 | 0.15 wt. % | 60° C. | 0.007 | 0.032 |
| Example 4 | 0.05 wt. % | 45° C. | 0.010 | 0.032 |
| Example 5 | 0.05 wt. % | 60° C. | Not | 0.032 |
| | | | measured | |
| Comparative | — | 45° C. | 0.020 | 0.032 |
| Example 1 | | | | |
| Comparative | — | 60° C. | Not | 0.032 |
| Example 2 | | | measured | |
| Comparative | — | 25° C. | Not | 0.032 |
| Example 3 | | | measured | |

The results demonstrate the following. In each of the alkaline storage batteries of Examples 1 to 4, the surface layer of the hydrogen-absorbing alloy particles had a weight ratio of Ni to Al significantly lower than the weight ratio of Ni to Al in the interior portion of the alloy. In all the alkaline storage batteries of Examples 1 to 4, the weight ratios of Ni to Al were 0.015 or less. Note that, in each of the alkaline storage batteries of Examples 1 to 4, the aluminum compound Al(OH)₃ was added to, or combined with, the hydrogen-absorbing alloy powder, and each of the batteries was obtained by setting the assembled alkaline storage battery aside under high temperature. In contrast, the alkaline storage battery of Comparative Example 1 had a weight ratio of Al to Ni greater than 0.015 in the surface layer of the hydrogen-absorbing alloy particles. Note that in the alkaline storage battery of Comparative Example 1, no aluminum compound Al(OH)₃ was added to the hydrogen-absorbing alloy powder, although the assembled alkaline storage battery was set aside under high temperature. It should be noted that in the alkaline storage battery of Example 5 as well, the aluminum compound Al(OH)₃ was added to the hydrogen-absorbing alloy powder, and the alkaline storage battery of Example 5 was obtained by setting the assembled alkaline storage battery aside under high temperature. Therefore, it is believed that, in the alkaline storage battery of Example 5 as well, the surface layer of the hydrogen-absorbing alloy particles has a weight ratio of Al to Ni of 0.015 or less, which is significantly lower than the weight ratio of Al to Ni in the interior portion of the alloy, as in the cases of the alkaline storage batteries of Examples 1 to 4 above, although the weight ratio of Al to Ni in the surface layer of the hydrogen-absorbing alloy particles was not measured.

Next, the alkaline storage batteries of Examples 1 to 5 and Comparative Examples 1 to 3, prepared in the above-described manners, were charged at a current of 1500 mA until the battery voltage reached the maximum value, and then further charged until the battery voltage was reduced by 10 mV. Thereafter, the batteries were discharged at a current of 1500 mA until the battery voltage reached 1.0 V, to complete one cycle. This charge-discharge cycle was repeatedly performed to obtain the cycle life for each battery, which was defined as the number of cycles at which the discharge capacity of the battery reduced to 60% of that at the first cycle. The results are shown in Table 2 below.

In addition, the operating voltages and the internal resistances were measured for the alkaline storage batteries of Example 1 and Comparative Example 1, at the time when the alkaline storage batteries were charged and discharged for 200 cycles. The results are shown in Table 3.

TABLE 2

| | Amount of | Temperature at | |
|---|---|---|---|
| | Al(OH)₃ with | which battery | |
| | respect to | was set aside | |
| | hydrogen- | before charge | Cycle life |
| | absorbing alloy | and discharge | (cycle) |
| Example 1 | 0.30 wt. % | 45° C. | 390 |
| Example 2 | 0.15 wt. % | 45° C. | 395 |
| Example 3 | 0.15 wt. % | 60° C. | 395 |
| Example 4 | 0.05 wt. % | 45° C. | 385 |
| Example 5 | 0.05 wt. % | 60° C. | 395 |
| Comparative | — | 45° C. | 360 |
| Example 1 | | | |
| Comparative | — | 60° C. | 360 |
| Example 2 | | | |
| Comparative | — | 25° C. | 345 |
| Example 3 | | | |

TABLE 3

| | | Temperature | | |
|---|---|---|---|---|
| | Amount of | at which | | |
| | Al(OH)₃ with | battery was | | |
| | respect to | set aside | | |
| | hydrogen- | before | 200th cycle | |
| | absorbing | charge and | Operating | Internal |
| | alloy | discharge | voltage | resistance |
| Example 1 | 0.30 wt. % | 45° C. | 1.190 V | 38.5 mΩ |
| Comparative | — | 45° C. | 1.186 V | 44.5 mΩ |
| Example 1 | | | | |

The results demonstrate that the alkaline storage batteries of Examples 1 to 5, in each of which the aluminum compound Al(OH)₃ was added to the hydrogen-absorbing alloy powder and each of which was obtained by setting the assembled alkaline storage battery aside under high temperature, exhibited significant improvements in cycle life over the alkaline storage batteries of Comparative Examples 1 to 3. Moreover, it is demonstrated that the alkaline storage battery of Example 1 exhibited a higher operating voltage and a lower internal resistance than the alkaline storage battery of Comparative Example 1, at the time when the batteries were charged and discharged for 200 cycles.

In addition, as for the amount of the aluminum compound Al(OH)₃ added to the hydrogen-absorbing alloy powder, it was observed that the advantageous effects were attained when the amount of the aluminum compound Al(OH)₃ added to the hydrogen-absorbing alloy powder was within the range of from 0.05 wt % to 0.30 wt %. Furthermore, as for the temperature at which the assembled alkaline storage battery was set aside, it was observed that the advantageous effects were obtained when the temperature was within the range of from 45° C. to 60° C.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

This application claims priority of Japanese patent application Nos. 2005-281103 and 2006-051841 filed Sep. 28, 2005, and Feb. 28, 2006, respectively, which are incorporated herein by reference.

What is claimed is:

1. A hydrogen-absorbing alloy electrode comprising hydrogen-absorbing alloy particles containing at least a rare-earth element, nickel, magnesium, and aluminum, the hydrogen-absorbing alloy particles having an interior portion and a surface layer formed thereon, wherein the surface layer has a weight ratio of aluminum to nickel less than that of the interior portion, and the weight ratio of aluminum to nickel in the surface layer is 0.015 or less.

2. The hydrogen-absorbing alloy electrode according to claim 1, wherein the hydrogen-absorbing alloy particles comprise a hydrogen-absorbing alloy represented by the general formula Ln₁₋ₓMgₓNi_{y-a-b}AlₐM_{b}, where Ln is at least one element selected from rare-earth elements including Y; M is at least one element selected from the group consisting of V, Nb, Ta, Cr, Mo, Mn, Fe, Co, Ga, Zn, Sn, In, Cu, Si, P, B, Zr, and Ti; 0.05≦x≦0.35; 2.8≦y≦3.9; 0.05≦a≦0.30; and 0≦b≦0.5.

3. An alkaline storage battery comprising a positive electrode, a negative electrode, a separator interposed between the positive electrode and the negative electrode, and an alkaline electrolyte solution, the negative electrode being a hydrogen-absorbing alloy electrode according to claim 1.

4. A method of manufacturing an alkaline storage battery as set forth in claim 3, the method comprising:
assembling an alkaline storage battery comprising a positive electrode; a negative electrode comprising a hydrogen-absorbing alloy comprising hydrogen-absorbing alloy particles containing at least a rare-earth element, nickel, magnesium, and aluminum; a separator to be interposed between the positive electrode and the negative electrode; and an alkaline electrolyte solution; and
thereafter charging and discharging the alkaline storage battery.

5. The method according to claim 4, further comprising setting the alkaline storage battery aside under high temperature, and, after a battery voltage has stabilized, charging and discharging the alkaline storage battery.

6. The method according to claim 5, wherein the alkaline storage battery is set aside at a temperature within a range of from 45° C. to 60° C.

7. The method according to claim 4, further comprising, in the step of assembling the alkaline storage battery, combining an aluminum compound with the hydrogen-absorbing alloy particles of the negative electrode.

8. The method according to claim 7, wherein the aluminum compound combined with the hydrogen-absorbing alloy of the negative electrode is an oxide or hydroxide of aluminum.

9. The method according to claim 7, wherein the amount of the aluminum compound combined with the hydrogen-absorbing alloy of the negative electrode is within a range of from 0.05 weight % to 0.3 weight % with respect to the hydrogen-absorbing alloy.

10. An alkaline storage battery comprising a positive electrode, a negative electrode, a separator interposed between the positive electrode and the negative electrode, and an alkaline electrolyte solution, the negative electrode being a hydrogen-absorbing alloy electrode according to claim 2.

11. A method of manufacturing an alkaline storage battery as set forth in claim 10, the method comprising:
assembling an alkaline storage battery comprising a positive electrode; a negative electrode comprising a hydrogen-absorbing alloy comprising hydrogen-absorbing alloy particles containing at least a rare-earth element, nickel, magnesium, and aluminum; a separator to be interposed between the positive electrode and the negative electrode; and an alkaline electrolyte solution; and
thereafter charging and discharging the alkaline storage battery.

12. The method according to claim 11, further comprising setting the alkaline storage battery aside under high temperature, and, after a battery voltage has stabilized, charging and discharging the alkaline storage battery.

13. The method according to claim 12, wherein the alkaline storage battery is set aside at a temperature within a range of from 45° C. to 60° C.

14. The method according to claim 11, further comprising, in the step of assembling the alkaline storage battery, combining an aluminum compound with the hydrogen-absorbing alloy particles of the negative electrode.

15. The method according to claim 12, further comprising, in the step of assembling the alkaline storage battery, combining an aluminum compound with the hydrogen-absorbing alloy particles of the negative electrode.

16. The method according to claim 13, further comprising, in the step of assembling the alkaline storage battery, combining an aluminum compound with the hydrogen-absorbing alloy particles of the negative electrode.

17. The method according to claim 14, wherein the aluminum compound combined with the hydrogen-absorbing alloy of the negative electrode is an oxide or hydroxide of aluminum.

18. The method according to claim 15, wherein the aluminum compound combined with the hydrogen-absorbing alloy of the negative electrode is an oxide or hydroxide of aluminum.

19. The method according to claim 16, wherein the aluminum compound combined with the hydrogen-absorbing alloy of the negative electrode is an oxide or hydroxide of aluminum.

20. The method according to claim 14, wherein the amount of the aluminum compound combined with the hydrogen-absorbing alloy of the negative electrode is within a range of from 0.05 weight % to 0.3 weight % with respect to the hydrogen-absorbing alloy.

21. The method according to claim 15, wherein the amount of the aluminum compound combined with the hydrogen-absorbing alloy of the negative electrode is within a range of from 0.05 weight % to 0.3 weight % with respect to the hydrogen-absorbing alloy.

22. The method according to claim 16, wherein the amount of the aluminum compound combined with the hydrogen-absorbing alloy of the negative electrode is within a range of from 0.05 weight % to 0.3 weight % with respect to the hydrogen-absorbing alloy.

23. The method according to claim 17, wherein the amount of the aluminum compound combined with the hydrogen-absorbing alloy of the negative electrode is within a range of from 0.05 weight % to 0.3 weight % with respect to the hydrogen-absorbing alloy.

24. The method according to claim 18, wherein the amount of the aluminum compound combined with the hydrogen-absorbing alloy of the negative electrode is within a range of from 0.05 weight % to 0.3 weight % with respect to the hydrogen-absorbing alloy.

25. The method according to claim 19, wherein the amount of the aluminum compound combined with the hydrogen-absorbing alloy of the negative electrode is within a range of from 0.05 weight % to 0.3 weight % with respect to the hydrogen-absorbing alloy.
